(19) United States
(12) Patent Application Publication
(10) Pub. No.: US 2007/0043615 A1
(43) Pub. Date: Feb. 22, 2007

(54) Product specific customer targeting

(75) Inventors: Munther A. Dahleh, Cambridge, MA (US); Sridevi Sarma, Cambridge, MA (US); Jeff Shamma, Glendale, CA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Infolenz Corporation, Cambridge, MA (US)

(21) Appl. No.: 11/375,377

(22) Filed: Mar. 14, 2006

Related U.S. Application Data
(60) Provisional application No. 60/661,816, filed on Mar. 15, 2005.

(51) Int. Cl. G06Q 30/00

(52) U.S. Cl. 705/14

(57) ABSTRACT

A method for selecting a target group of customers for promoting a product is based on data representing individual buying patterns for a pool of customers over a set of products a product to be promoted. A first subset of customers is selected whose buying patterns can form a behavioral benchmark for the selection of the target group of customers. A market model for the product set is constructed and a second subset of customers is selected who are considered to be potentially interested in a product to be promoted. The second subset of customers is scored according to their similarity to customer segments in the benchmark customer market model and a third subset is selected based upon their scores. Members of the third subset are matched to products according to product segments for which they have demonstrated similarity. Offer parameters indicating collaborative promotions can then be output.

### CROSS-REFERENCE TO RELATED APPLICATIONS

This application claims priority to U.S. Provisional Application No. 60/661,816, filed Mar. 15, 2005, entitled “Product Specific Customer Targeting,” which is incorporated by reference herein.

### BACKGROUND OF THE INVENTION

Vendors are continually looking for better ways to market their products to the buying population. Promotions are one tool available to marketing professionals to improve sales. Promotions typically include media and non-media marketing communications employed for a predetermined, limited time to increase consumer demand, stimulate market demand or improve product availability. Examples include:

coupons

discounts and sales

contests

point of purchase displays

rebates

gifts and incentive items

free travel, such as free flights

Sales promotions can be directed at either the customer, sales staff, or distribution channel members (such as retailers). Sales promotions targeted at the consumer are called consumer sales promotions. Sales promotions targeted at retailers and wholesale are sometimes called trade sales promotions.

As part of this effort, vendors provide economic incentives and promotions which are strategically targeted to achieve a desired result. One type of targeting involves selecting an appropriate product or product line to be offered in the promotion. Another aspect of targeting includes selection of the appropriate target population to which the promotion will be offered. For optimum results, various specific combinations of products and targeted potential buyers will be packaged in specific promotional offerings.

### BRIEF SUMMARY OF THE INVENTION

One goal of the present invention is to select a target group of customers for the promotion of a specific product. This group of customers can be selected from a pool of customers whose buying patterns may or may not indicate a prior interest in the promotional product. The present disclosure describes an exemplary method and tool for achieving this goal.

Some exemplary applications of the Product Specific Customer Targeting (PSCT) invention include:

Find those customers most likely to respond to a product promotion.

Suggest complementary products to be used in collaborative promotions.

Evaluate collaborative promotions by estimating revenue returns for different collaborative product mixes and different pricing discount models.

Aspects of the present disclosure relate to formulation of promotional offerings intended to sell a particular product in a product line available from the vendor. The product is promoted to persons more likely as well as those less likely to purchase the product.

Purchasing behavior is tracked, and a history is compiled of products purchased by people who also purchased this specific product which is to be promoted. Developing such buyer signatures makes it possible to identify potential buyers who will be more likely to purchase the promoted product.

Based on the signature of any given individual, potential buyers may be categorized by their aggregate signature into top tier buyers and lower tier buyers. These tiers are not compiled using demographic data per se, but are normally compiled based on the purchasing behavior and inclinations as demonstrated in the market place. Of course, demographic information may also be used in determining the signatures and final promotions offered to the potential buyers.

Generally, top tier buyers are those who previously bought more of the product to be promoted (call it X) than any other product. Top tier buyers may also be defined as persons who bought more of X than most other buyers of X. Each of these two types of top tier buyers will have an aggregated group signature that can be extracted and represented numerically as a vector, for example. A meaningful association of the values in the vector can produce results usable for constructing product-specific promotions.

In addition to the top tier buyers, lower tier buyers are identified by a signature which indicates a poor propensity to purchasing the promoted product. This information is also useful and usable in formulating the promotions.

In developing the product-specific promotions, one object is to cause all buyers in general to move upward on the scale towards the ideal top tier buyer level. That is, one object is to get those with a slight propensity to buy the product to have a greater inclination to buy the product. Similarly, a goal is to have those with a poor propensity to buy the product to have a better inclination to buy the product. Different promotions may be offered to different purchasers based on which tier they fall into. For example, people who have bought product X are compared to those in the top tier, and people who have never bought the product are compared to those buyers who have bought modest amounts of X. Lower tier purchasers are also compared to the top tier purchasers. All of this information is used to provide useful, targeted promotions which generate increased sales and profits.

In one example, greater incentives are given to those lower on the buyer signature scale than would be offered to those ideal customers who already are very likely to purchase product X.

Promotions are not limited to percentage discounts, but also include offering other products than X along with X. For example, a package offering which might promote the sale of product X can include a discount on product Y that the targeted customer is more likely to be enticed by. Therefore, a computation of an offering that provides 10% discount on X in combination with a 20% discount for Y could be the ideal promotion to a certain potential buyer.

### BRIEF DESCRIPTION OF THE DRAWINGS

The invention will be more fully understood from the following detailed description taken in conjunction with the accompanying drawings:

FIG. 1 illustrates a flow of method steps according to one embodiment of the invention for selecting a target group of customers for the promotion of a product;

FIG. 2 provides a chart of assumed revenue generation at various discounts on products according to one specific embodiment of the invention as shown in FIG. 1; and

FIG. 3 illustrates a system of the invention for selecting a target group of customers for the promotion of a product.

### DETAILED DESCRIPTION OF THE INVENTION

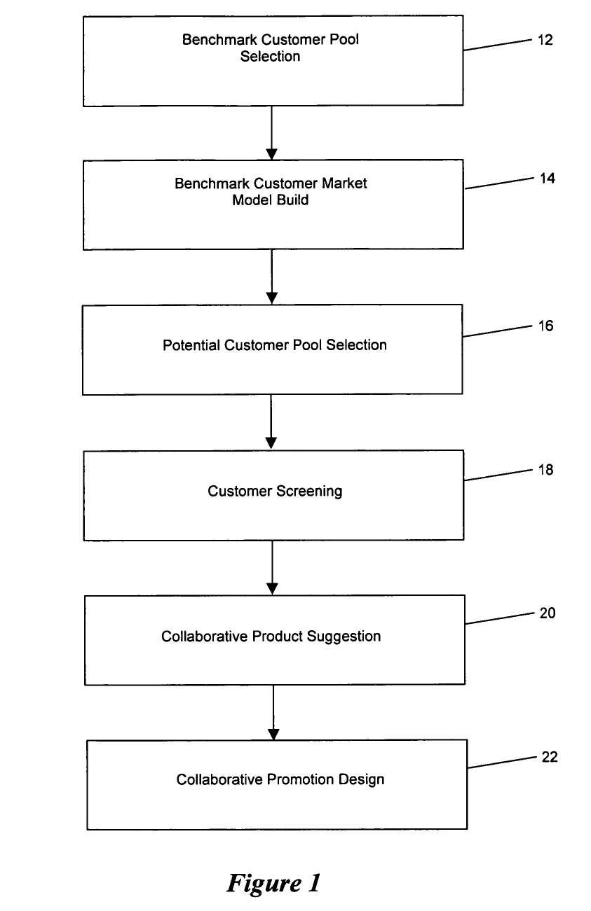

A method of one aspect of the invention for selecting a target group of customers for the promotion of a product can be described with reference to FIG. 1. The starting data for use with this method can include individual buying patterns for a pool of customers over a set of products, one of which is the product to be promoted. This data can be transaction data that already exists within an organization, such as data reflecting on-line purchasing transactions, in-store purchasing transactions, catalog purchasing transactions, affinity or benefit card related transactions, or transactions that are tracked specifically for use in providing a data set for use with the invention.

The main steps illustrated in the embodiment of FIG. 1 are as follows:

1. Benchmark customer pool selection 12: A subset of customers is selected whose prior purchases of the promotional product suggest that their buying patterns across all departments can form a behavioral benchmark for the selection of targeted customers.

2. Benchmark customer market model build 14: A Market Model is constructed using the benchmark customer pool. The Market Model includes all offered products from the product set except the promotional product under consideration.

3. Potential customer pool selection 16: A subset of customers is selected who are considered to be potentially interested in the promotional product.

4. Customer screening 18: Members of the potential customer pool are scored according to their similarity to customer segments in the benchmark customer Market Model. High scoring members are selected for product promotion.

5. Collaborative product suggestion 20: The selected potential customers are matched to different products according to the product segment in which they demonstrated similarity to the benchmark customer Market Model.

6. Collaborative promotion design 22: Collaborative promotions are evaluated according to an appropriate pricing models.

This embodiment of the invention can use the illustrated steps for at least two sorts of promotions:

Introduction: Entice non-buyers of the promoted product to a first-time purchase.

Elevation: Entice previous buyers of the promoted product to purchase again.

### Exemplary Embodiment Illustrating Introduction Promotions

The overall market can be described as consisting of products {P₀, P₁, P₂, . . . , Pₙ}, where P₀ is the product to be promoted using the invention. The input data to this method for this situation is individual customer purchases of these products over a given time period.

The framework for performing this analysis can vary. The “product line” of products considered may also include various departments, and individual customer purchases may also be aggregated customer purchases among departments.

Benchmark Customer Pool Selection 12

The first step is to select a group of customers that will be used to define a “signature” of buyers of product P₀. Possible choices include:

P₀ buyers: Select anyone who bought product P₀.

{Above/Below} average P₀ buyers: Compute the average spent on P₀ over all P₀ buyers. Select P₀ buyers who spent more/less than this average.

Peak P₀ buyers: Select P₀ buyers who spent more on P₀ than on any other product.

Each of these groups exhibit different purchase patterns that may be representative of interest in P₀ by non-P₀ buyers. For example, the Below Average group reflects a modest interest in P₀. This behaviour may produce a better benchmark to attract non-buyers than the Above Average group.

Because of the various relative advantages of these benchmark pools, the PSCT invention allows the user to use one or more benchmark pools with user specified relative importance.

Benchmark Customer Market Model Build 14

The next step is to build a Market Model using 1) the benchmark customer pool and 2) products {P₁, . . . , Pₙ}, i.e., all products except for the product being promoted, P₀. The idea is to use the benchmark pool purchases outside of P₀ to form a signature to use to select non-P₀ buyers. For example, non-P₀ buyers who exhibit similar purchase patterns outside of P₀ may be likely candidates to purchase P₀. The Market Model or Market Map used herein can be the Market Map described in U.S. patent application Ser. No. 10/051,548, filed on Jan. 16, 2002, and entitled “System and Method for Association of Object Sets,” which application is incorporated by reference herein, or other Market Models could be used.

In some embodiments, the benchmark group should have sufficient activity outside of P₀ to qualify to produce a purchase pattern signature. One way to evaluate this activity is by requiring:

$$\frac{total spent on {P}_{1} , … , {P}_{n}}{total spent on {P}_{0} , … , {P}_{n}}$$

to be sufficiently large.

Potential Customer Pool Selection 16

In the case of P₀ introduction, the potential customer pool is non-buyers of P₀.

Customer Screening 18

Two examples of customer screening are provided below, customer screening using a single benchmark pool, and using a multiple benchmark pool:

Single Benchmark Pool

Suppose the Market Model results in product segments {PS₁, . . . , PSₘ}. Let H be the associated block m-by-m matrix with rows

$$H = ( \begin{matrix}{h}_{1}^{T} \\ ⋮ \\ {h}_{m}^{T}\end{matrix} )$$

Each member of the potential customer pool is assigned a score consisting of two components: 1) an inner product score and 2) a product segment association. These components are computed as follows:

1. Let

$$u = ( \begin{matrix}{u}_{1} \\ ⋮ \\ {u}_{m}\end{matrix} )$$

denote a customer's purchases commensurate with the product segments {PS₁, . . . , PSₘ}.

2. Compute the m-numbers, sᵢ:
sᵢ=hᵢ^{T}v

3. A customer's score is the two components (s*, i*) where

$${s}^{*} = {max}_{i} {s}_{i}$$

$${i}^{*} = arg {max}_{i} {s}_{i}$$

i.e., the maximum inner product value and the index that produced that value.

In words, a customer's score is derived from an inner product between a customer's purchase patterns and the purchase patterns of a benchmark customer segment. The two score components correspond to the maximum such inner product and the product segment in which the maximum occurs. Several factors contribute to the size of the inner product score, including 1) alignment with the benchmark customer segment, 2) overall size of the customer's purchases, and 3) overall size of the benchmark segment purchases.

At least two methods may be used to select the top scoring customers:

Ranking: Customer scores are ranked, and a top group is selected.

Skimming: The product segment component of scores is used to sort customers into different product segment bins. First, a top percentile of each bin is selected. Second, a top percentile over all bins is selected.

Multiple Benchmark Pools

As mentioned earlier, it may be desirable to have multiple benchmark pools. Accordingly:

Non-P₀ Market Models are preferably consistent, i.e., have the same product segments.

The inner products among benchmark pools is preferably normalized to allow relative comparisons. Two possibilities are:

Within each benchmark pool, convert inner product scores to an overall rank.

Within each benchmark pool, divide by a statistical normalization factor, such as the mean plus the standard deviation.

The normalized scores from each benchmark pool are now summed to produce an overall inner product score.

The final associated product segment is the benchmark pool association that produced the largest normalized inner product score.

As an example, suppose there are 2 benchmark pools, A and B, and the Market Model size m=3. Let s_{A} denote a customer's inner products with respect to pool A. Similarly define s_{B}. Suppose:

$${s}_{A} = ( \begin{matrix}{s}_{A , 1} \\ {s}_{A , 2} \\ {s}_{A , 3}\end{matrix} ) = ( \begin{matrix}0.8 \\ 0.9 \\ 0.1\end{matrix} )$$

$${s}_{B} = ( \begin{matrix}{s}_{B , 1} \\ {s}_{B , 2} \\ {s}_{B , 3}\end{matrix} ) = ( \begin{matrix}11 \\ 11 \\ 12\end{matrix} )$$

If pool A were the only benchmark pool, this customer's score would be (0.9, 2). If pool B were the only benchmark pool, the score would be (12, 3). Since both pools are used, the customer's inner product score of this will be a normalized sum of 0.9 and 12, and the product association will either be 2 or 3, depending on the actual normalization.

As before, two possibilities to select the top customers are:

Ranking: Normalized and summed scores are ranked, so that a customer may be selected based on the combined performance with respect to all of the benchmark pools.

Skimming: The skimming procedure outlined previously is applied to each individual pool, so that a customer may be selected based on performance with respect to any single benchmark pool.

Collaborative Product Suggestion 20

Customer selection, i.e., single versus multiple benchmark pools and ranking versus skimming selection, result in both inner product scores and product segments associations. A histogram of the product segment associations of the top group may be produced to show the product segments that produced the top scores. These are the product segments to be considered for bundled promotions.

Collaborative Promotion Design 22

The following pricing tools may be used to evaluate possible promotions.

Flat discount revenue predictor

Bundled promotion revenue predictor

Revenue proxy generator

Flat Discount Revenue Predictor

The starting data is historical revenue of cumulative sales versus percent discount on a particular product, denoted rᵢ as a function of dᵢ, and the zero discount unit price of the product, u.

The Flat Discount Revenue Predictor answers the question: What would be the revenue generated if a discount of d % were given now? The model computes the new revenue under the assumption that the historical revenue dictates the number of units which can be sold at a given discount.

Let r* be the predicted revenue for an offered discount of d*. Then

$${r}^{*} = {\sum }_{{d}_{i} \leq {d}^{*}} \frac{{r}_{i}}{u ( 1 - {d}_{i} )} u ( 1 - {d}^{*} ) = ( 1 - {d}^{*} ) {\sum }_{{d}_{i} \leq {d}^{*}} \frac{{r}_{i}}{1 - {d}_{i}}$$

Note that the unit price need not enter into the computation.

The resulting new revenue is less than the historical cumulative revenue. For this reason, it is not desirable to select a discount based on a peak of the predicted revenue. One alternate approach is to examine the overall percent lost due to a flat discount promotion. A favorable situation is where a higher discount can generate higher revenue without resulting in an increased percentage loss over historical data.

Bundled Promotion Revenue Predictor

The starting data is historical revenue of cumulative sales versus percent discount, denoted rᵢ^{A} and rᵢ^{B} as a function of dᵢ, on two particular products, say P_{A} and P_{B}, and the unit prices of these products, u_{A} and u_{B}.

The Bundled Promotion Revenue Predictor answers the question: What would be the revenue generated if discount of d*_{A} and d*_{B} were offered on a bundle of P_{A} and P_{B} at a ratio of n_{A}:n_{B}?

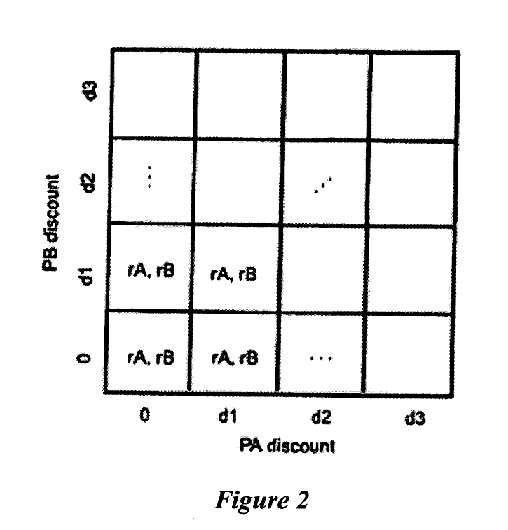

The bundled revenue prediction is based on an assumed distribution of revenue generated at various discounts on products P_{A} and P_{B} is illustrated in FIG. 2. Each cell in FIG. 2 may be viewed as a customer who purchased P_{A} and P_{B} at the indexed discounts of the cell. The revenue numbers in each cell is the amount purchased.

Since such joint distribution data is not typical, it may be derived from the individual revenue distributions as follows:

1. Given the revenue curve, rᵢ^{A}, compute the total P_{A} revenue

$${R}^{A} = {max}_{i} {r}_{i}^{A}$$

2. Compute the density function ρᵢ^{A} as
ρ₀^{A}=r₀^{A}/R^{A}
ρᵢ^{A}=(rᵢ^{A}−r₍ᵢ₋₁₎₎^{A}/R^{A}, i≧1

3. Similarly compute R^{B} and ρᵢ^{B}

4. Let rᵢⱼ^{A} denote the revenue of P_{A} associated with the cell in FIG. 1 with a discount dᵢ on P_{A} and dⱼ on P_{B}. Similarly define rᵢⱼ^{B}. Then set
rᵢⱼ^{A}=R^{A}ρᵢ^{A}ρⱼ^{B}
rᵢⱼ^{B}=R^{B}ρᵢ^{A}ρⱼ^{B}

Associated with each cell is a “strike price”, i.e., a price that would indicate interest in a given bundle. Consider a bundle at a ratio of n_{A}:nB with unit prices u_{A} and u_{B} and product discounts d*_{A} and d*_{B}. The bundle price is
p_{bundle}=n_{A}u_{A}(1−d*_{A})+n_{B}u_{B}(1−d*_{B})

The strike price of the ij^{th} cell is
pₛₜᵣᵢₖₑ(i,j)=n_{A}u_{A}(1−dᵢ)+n_{B}u_{B}(1−dⱼ)

The interpretation is that if p_{bundle}≦Pₛₜᵣᵢₖₑ(i,j), then cell ij is interested in the bundle.

Suppose that a particular cell's strike price is met. The number of bundles that cell ij will purchase is

$${N}_{ij} = min \{ \frac{{r}_{ij}^{A}}{( 1 - {d}_{i} ) {u}_{A} {n}_{A}} , \frac{{r}_{ij}^{B}}{( 1 - {d}_{j} ) {u}_{B} {n}_{B}} \}$$

i.e., the cell seeks to purchase the same number of units of P_{A} or P_{B} suggested by the joint revenue distributions. In particular, if either rᵢⱼ^{A} or rᵢⱼ^{B} is zero, then the cell does not participate in the bundle, even if its strike price was met.

The total revenue generated by a bundle is computed as
(Σ_{Pbundle≦Pstrike(i,j)}N_{ijPbundle})+(0% P_{A} remainder)+(0% P_{B} remainder)

where the “remainder” terms are residual revenue at 0% discount of products P_{A} and P_{B}.

Revenue Proxy Generator

In the case of introduction, there is no historical data on customer target pool purchases of the promotional product, P₀. Therefore, a proxy revenue curve can be used. The revenue proxy generator may use a model revenue versus discount curve to generate a proxy that satisfies certain user specified data. Suppose r(d) is a model revenue curve, and

$$r ( d ) = r ( 0 ) + {\int }_{0}^{d} {r}^{′} ( t ) ⅆ t$$

The proxy revenue curve, rx(d), is

$${r}_{x} ( d ) = {r}_{x} ( 0 ) + γ {\int }_{0}^{d} {r}^{′} ( t ) ⅆ t$$

where γ>0 is computed based on a user specified rₓ(0) and rₓ(1).

### Exemplary Embodiment Illustrating Elevation Promotions

In some embodiments, the algorithm for Elevation differs from that of Introduction only in the definition of the target and benchmark groups.

Suppose the potential customer pool is below average P₀ buyers. Candidates for a benchmark pool include, as before, peak buyers, above average buyers, and below average buyers. Using a group to score itself can remove outliers.

Suppose the potential customer pool is above average P₀ buyers. In some cases, it may be desirable to remove above average buyers who bought large volumes at high discounts. Then candidates for a benchmark pool include peak buyers and above average buyers. Again, a pool is used to score itself.

Regarding collaborative promotion design, the case of Elevation allows the use of historical revenue curves to predict the response to a promotion. In the case of Introduction, proxy revenue curves can be used because the targeted pool did not buy the product being promoted. Proxy revenue curves may be appropriate in the case of Elevation, e.g., to explore various hypothetical scenarios, such as pessimistic or optimistic responses to a promotion.

Systems of the Invention

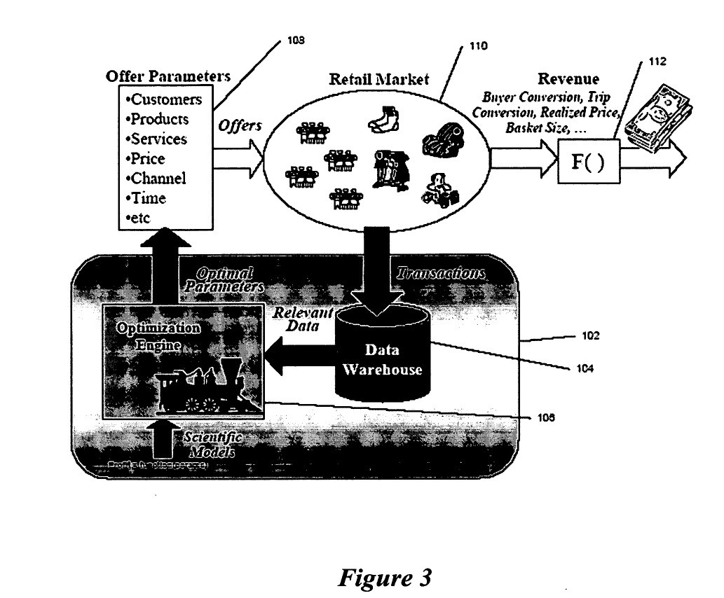

An exemplary system of the invention that is capable, inter alia, of performing the methods described above is illustrated in FIG. 3. The system of FIG. 3 includes a workstation computer 102 that includes data storage 104 for storing data warehouse information relating to purchasing transactions and processor or optimization engine 106. Workstation computer 102 can be any common computer system having a processor and memory for storing instructions and scientific models for carrying out methods such as those described above. In one embodiment, workstation 102 is a general purpose computer programmed in software to carry out methods of the invention described above. A person of ordinary skill in the art will also recognize that, instead of a single workstation, that the system could include a number of networked computers, and that data warehouse 104 need not physically reside on the same system as the processor 106, but could, for example, reside on a special purpose digital system configured to collect and store transaction data or other general purpose digital system capable of such storage. In particular, data warehouse 104 can be applied to extract relevant data from among the transaction data stored in the warehouse for use as an input to processor 106.

Output from the processor 106 includes offer parameters 108. Offer parameters 108 can be in digital form and be communicated digitally to an offer or promotion management server or other content management server that can be used to deliver promotional offers automatically. Alternatively, offer parameters 108 can be reported to a marketing professional for evaluation and promotion management. Promotional offers are then communicated to the retail market 110 in order to drive further transactions. These transactions preferably result in additional or optimized revenue 112 and profit. Data from these transactions are fed back into data warehouse 104. As a result, the effectiveness of previous offer parameters can be analyzed, reported on, and included in the optimization of new offer parameters 108 by processor 106. Again, this feedback, reporting and use may be fully automated, or it may rely on marketing professionals to direct it.

The invention being thus disclosed and illustrative embodiments depicted herein, further variations and modifications of the invention will occur to those skilled in the art. All such variations and modifications are considered to be within the scope of the invention, as defined by the claims appended hereto and equivalents thereof.

What is claimed is:

1. A method for selecting a target group of customers for the promotion of a product based on data representing individual buying patterns for a pool of customers over a set of products, at least one of which is a product to be promoted, comprising:
selecting from the pool of customers a first subset of customers whose prior purchases of a product to be promoted suggest that their buying patterns can form a behavioral benchmark for the selection of the target group of customers;
constructing a market model using the first subset of customers, the market model including all offered products from the product set except for a product to be promoted;
selecting a second subset of customers who are considered to be potentially interested in a product to be promoted;
scoring the second subset of customers according to their similarity to customer segments in the benchmark customer market model and selecting a third subset of customers based upon their scores;
matching the third subset of customers to the at least one product to be promoted according to the product segment in which they demonstrated similarity to the market model; and
outputting offer parameters indicating collaborative promotions to be directed to the third subset of customers based upon a pricing model.

2. The method of claim 1, wherein the promotion is an introduction promotion designed to entice non-buyers of a product to be promoted to buy for the first time.

3. The method of claim 1, wherein the promotion is an elevation promotion designed to entice previous buyers of a product to be promoted to buy again.

4. The method of claim 1, wherein selecting a second subset of customers is performed using a single benchmark pool.

5. The method of claim 1, wherein selecting a second subset of customers is performed using multiple benchmark pools.

6. The method of claim 1, wherein the pricing model is a flat discount revenue predictor.

7. The method of claim 1, wherein the pricing model is a bundled promotion revenue predictor.

8. The method of claim 1, wherein the pricing model is a revenue proxy generator.

9. A system for selecting a target group of customers for the promotion of a product, comprising:
a data warehouse storing data representing individual buying patterns for a pool of customers over a set of products, at least one of which is a product to be promoted; and
a processor configured to:
select from the pool of customers a first subset of customers whose prior purchases of a product to be promoted suggest that their buying patterns can form a behavioral benchmark for the selection of the target group of customers;
construct a market model using the first subset of customers, the market model including all offered products from the product set except for a product to be promoted;
select a second subset of customers who are considered to be potentially interested in a product to be promoted;
score the second subset of customers according to their similarity to customer segments in the benchmark customer market model and selecting a third subset of customers based upon their scores;
match the third subset of customers to the at least one product to be promoted according to the product segment in which they demonstrated similarity to the market model; and
output offer parameters indicating collaborative promotions to be directed to the third subset of customers based upon a pricing model.

10. The system of claim 1, wherein the promotion is an introduction promotion designed to entice non-buyers of a product to be promoted to buy for the first time.

11. The system of claim 1, wherein the promotion is an elevation promotion designed to entice previous buyers of a product to be promoted to buy again.

12. The system of claim 1, wherein selecting a second subset of customers is performed using a single benchmark pool.

13. The system of claim 1, wherein selecting a second subset of customers is performed using multiple benchmark pools.

14. The system of claim 1, wherein the pricing model is a flat discount revenue predictor.

15. The system of claim 1, wherein the pricing model is a bundled promotion revenue predictor.

16. The system of claim 1, wherein the pricing model is a revenue proxy generator.
